(19) United States
(12) Patent Application Publication
(10) Pub. No.: US 2015/0106589 A1
(43) Pub. Date: Apr. 16, 2015

(54) SMALL FORM HIGH PERFORMANCE COMPUTING MINI HPC

(71) Applicant: REMTCS, Inc., Red Bank, NJ (US)

(72) Inventors: Tommy Xaypanya, Lamar, MS (US); Richard E. Malinowski, Colts Neck, NJ (US)

(21) Appl. No.: 14/516,453

(22) Filed: Oct. 16, 2014

Related U.S. Application Data
(60) Provisional application No. 61/891,598, filed on Oct. 16, 2013.

(51) Int. Cl. G06F 15/80

(52) U.S. Cl. CPC G06F 15/80
USPC 712/11

(57) ABSTRACT

A computing platform comprising a small form factor high performance computer for mobile high performance computing is provided. The computing platform comprises using small form factor design with a 64-core microprocessor/co-processor is provided. The small form factor high performance computer may include 64-core microprocessor/co-processors based on the ANNI Stem Cell HPC multicore datacenter chipset cluster of REMTEC.

### CROSS-REFERENCE TO RELATED APPLICATIONS

The present application claims the benefit of Provisional Patent Application No. 61/891,598, filed on Oct. 16, 2013, and is incorporated herein by reference in its entirety.

### FIELD OF THE DISCLOSURE

The present disclosure is generally directed toward portable high performance computing and more specifically to small form-factor high performance computing.

### BACKGROUND

High performance computing (HPC) began in the 1960s and generally refers to machines that have very large data processing capacities. These capacities may result from very fast processing devices, a very large number of processing devices, or both.

While most computer programs would benefit from faster execution, HPC allows programs that are so processing intensive that, absent HPC, the results of such programs would not be provided in a useful timeframe. For example, modeling automobile crash test has many advantages over actual crash tests. However, the results must be provided in a timely manner so that good designs can be advanced to the stage and bad designs can be quickly eliminated. If the virtual crash test could not produce results faster than actual crash tests then, despite the costs savings of virtual crash tests, manufacturers would likely find the lack of timeliness prohibitive.

### SUMMARY

It is with respect to the above issues and other problems that the embodiments presented herein were contemplated.

Certain embodiments described herein, generally relate to high performance computing. In one embodiment, portable high performance computing is provided utilizing multi-core microprocessor/co-processor (processor). The processor may comprise a number of cores arranged in a three dimensional (3D) array. The 3D array may be irregular (e.g., 2×3×4, 4×4×3, etc.) or a cube (e.g., 2×2×2, 3×3×3, 4×4×4, etc.). In one embodiment, the processor comprises a multicore, scalable, shared memory, parallel computing fabric, and further comprises a 3D array of computational nodes connected by a low-latency interlocking network-on-chip. In another embodiment, a high performance computing (HPC) platform is provided utilizing the processor and additional components, as will be described in more detail below, into blades and wherein the blades may form a server and wherein the server may be mobile. In another embodiment, the processor comprises a 64-core microprocessor/co-processor design based on the ANNI Stem Cell HPC multicore datacenter chipset cluster developed by REMTCS. In another embodiment, a hi

Another object of the present disclosure is to provide a small form-factor HPC that customized architecture defines a multicore, scalable, shared memory, parallel computing fabric and consists of a 3D array of computational nodes connected by a low-latency interlocking network-on-chip.

In another embodiment, a small form-factor HPC is provided comprising 64 high performance reduced instruction set computer (RISC) central processing unit (CPU) cores having a 64-bit architecture.

In another embodiment, a small form-factor HPC is provided comprising a 1 GHz operating frequency per mini processor board.

In another embodiment, a small form-factor HPC is provided comprising a 120 Gflops peak performance per mini HPC blade.

In another embodiment, a small form-factor HPC is provided comprising a 1.9 TBs/second local memory bandwidth per mini HPC blade.

In another embodiment, a small form-factor HPC is provided comprising a 120 GB/s network-on-chip bisection bandwidth per mini HPC blade.

In another embodiment, a small form-factor HPC is provided comprising an 8.4 GB/s off-chip bandwidth per HPC blade.

In another embodiment, a small form-factor HPC is provided comprising a 4 MB on-chip distributed shared memory per HPC blade.

In another embodiment, a small form-factor HPC is provided comprising a 4 watt maximum chip power consumption per HPC blade.

In another embodiment, a small form-factor HPC is provided comprising an IEEE floating point instruction set per HPC blade.

In another embodiment, a small form-factor HPC is provided comprising fully-featured ANSI-C/C++ programmable chipset per HPC blade.

In another embodiment, a small form-factor HPC is provided comprising GNU/Eclipse based tool chain per HPC blade.

In another embodiment, a small form-factor HPC is provided wherein at least one chipset comprises a source synchronous sub-LVDS off-chip links for host or direct chip-to-chip interfacing.

In another embodiment, a small form-factor HPC is provided comprising a chip-to-chip link operable to integrate up to 64 chips on a single board and which may further comprise a 324-ball 15×15 mm flip-chip BGA.

In another embodiment, a small form-factor HPC is provided comprising a chipset utilizing a chipset wrapping utilizing a fire-resistant textile board capable of 1,700 hours of continuous operation at 500 degrees Celsius. In a further embodiment, the chipset wrapping is a NASA compliant chipset wrapping.

In another embodiment, a small form-factor HPC where at least one processor comprises an independent superscalar floating-point RISC CPU operating at 1 GHz and 2.6 Gflops/sec. The CPU further comprising an efficient general-purpose instruction set that excels at compute intensive applications while being programmable in C/C++ without requiring programming utilizing assembly language or other processor-specific intrinsic.

In another embodiment, a small form-factor HPC is provided utilizing a memory architecture based on a flat memory map wherein each processor has a portion of the memory as local memory and comprising as a unique addressable slice of the total address space. A processor can access its own local memory and the local memory of other processors through regular load/store instructions. As a benefit, latency is very low and effective throughput is very high. In another embodiment, the local memory system is comprised of four separate banks, allowing for simultaneous memory access by the instruction fetch engine, local load-store instructions, and by load/store transactions initiated by other processors within system.

In another embodiment, a small form-factor HPC is provided comprising a network-on-chip. In another embodiment, the network-on-chip comprises a 3D interlocking network that handles on-chip and off-chip communication. The network-on-chip network may be based on 64-bit memory transactions transparent to the program running. The network comprises three separate and orthogonal interlocking structures, each serving different types of transaction traffic: one structure provides on-chip write traffic, another structure provides off-chip write traffic, and another structure provides read traffic.

In another embodiment, a small form-factor HPC is provided wherein the network and memory architecture is extended off-chip using source synchronous LVDS based serial links, such as to provide up to 1.6 GB/sec of effective bandwidth per link. In another embodiment, each processor comprises four links, one in each direction (north, east, west, south), allowing chips to interface with FPGAs and/or other processors.

What has been described and illustrated herein is a preferred embodiment of the disclosure along with some of its variations. The terms, descriptions and figures used herein are set forth by way of illustration only and are not meant as limitations. Those skilled in the art will recognize that many variations are possible within the spirit and scope of the disclosure in which all terms are meant in their broadest, reasonable sense unless otherwise indicated. Any headings utilized within the description are for convenience only and have no legal or limiting effect.

In some embodiments, a server is provided that generally comprises:

a number of computational blades;
a backplane operable to provide communication between at least two of the number of blades; and
wherein each blade comprises;
at least one computer chip, further comprising, a plurality of computational nodes, each computational node comprising a multi-core processor,
a memory comprising a shared portion and a plurality of local memory segments associated with each of the computational nodes;
a network-on-chip operable to provide data communication within the platform and comprising a low-latency mesh having first, second, and third interlocking structures and wherein on-chip write traffic of the data communication is allocated to the first interlocking structure, off-chip write traffic within the platform is allocated to the second interlocking structure, and on-chip and off-chip read within the platform traffic is allocated to the third interlocking structure; and
an off-chip input-output interface operable to facilitate communications with an external component.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising,” “including,” and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

The term “computer-readable medium” as used herein refers to any tangible storage that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, or any other medium from which a computer can read. When the computer-readable media is configured as a database, it is to be understood that the database may be any type of database, such as relational, hierarchical, object-oriented, and/or the like. Accordingly, the disclosure is considered to include a tangible storage medium and prior art-recognized equivalents and successor media, in which the software implementations of the present disclosure are stored.

The terms “determine,” “calculate,” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the disclosure is described in terms of exemplary embodiments, it should be appreciated that other aspects of the disclosure can be separately claimed.

### BRIEF DESCRIPTION OF THE DRAWINGS

The present disclosure is described in conjunction with the appended figures:

FIG. 1 depicts an illustrative multi-core processor in accordance with embodiments of the present disclosure;

FIG. 2 depicts an illustrative network-on-chip in accordance with embodiments of the present disclosure;

FIG. 3 depicts a first illustrative board in accordance with embodiments of the present disclosure;

FIG. 4 depicts a second illustrative board in accordance with embodiments of the present disclosure;

FIG. 5 depicts a third illustrative board in accordance with embodiments of the present disclosure; and

FIG. 6 depicts a fourth illustrative board in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. It being understood that various changes may be made in the function and arrangement of elements without departing from the spirit and scope of the appended claims.

The identification in the description of element numbers without a subelement identifier, when a subelement identifiers exist in the figures, when used in the plural, is intended to reference any two or more elements with a like element number. A similar usage in the singular, is intended to reference any one of the elements with the like element number. Any explicit usage to the contrary or further qualification shall take precedence.

The exemplary systems and methods of this disclosure will also be described in relation to analysis software, modules, and associated analysis hardware. However, to avoid unnecessarily obscuring the present disclosure, the following description omits well-known structures, components and devices that may be shown in block diagram form, and are well known, or are otherwise summarized.

For purposes of explanation, numerous details are set forth in order to provide a thorough understanding of the present disclosure. It should be appreciated, however, that the present disclosure may be practiced in a variety of ways beyond the specific details set forth herein.

In one embodiment, a processor is discloses. The processor further comprising 64-cores and configured to be operable as a microprocessor and/or co-processor. In another embodiment, the processor may comprise or perform according to one or more of: 64 high performance RISC CPU cores, 1 GHz operating frequency, 120 Gflops peak performance per mini HPC Blade, 1.9 TB/s local memory bandwidth, 120 GB/s network-on-chip bisection bandwidth, 8.4 GB/s off-chip bandwidth, 4 MB on-chip distributed shared memory, 4-Watt maximum chip power consumption, IEEE floating point instruction set, fully featured ANSI-C/C++ programmable, GNU/Eclipse based tool chain, source synchronous sub-LVDS off chip links for host or direct chip-to-chip interfacing, chip-to-chip links for integrating up to 64 chips on a single board, 324-ball 15×15 mm flip-chip BGA, and board construction is comprise a fire-resistant textile board capable of 1,700 hours of continuous operation at 500 degrees Celsius.

In another embodiment, a mini HPC cluster is provided comprising a plurality of processors. In a further embodiment, the plurality of processors is twelve processors in pairs of four (quad). As a benefit, 480 Gflops may be provided by a quad.

In another embodiment, two or more quads are stacked, such as to produce a petabyte or more of throughput in a small form factor, such as 3″×4″×4−6″. The form factor of the stack may be modified such as according to user need and/or environment.

In another embodiment, one or more processors executes an artificial intelligence (AI) engine operable to discern critical data in large data streams and delivering the critical information. For example, the AI engine analyzes content or communications and then reports findings, wherein the reporting may utilize low-bandwidth communications. As a benefit the opportunity to adjust the communications environment on collection assets may be provided to accommodate low bandwidth communications or provide the opportunity to apply the solution to systems that are currently constrained by their ability to carry and sustain continuous high bandwidth communications.

In another embodiment, an AI engine, such as one based on REMTCS Artificial Neural Network Intelligent Interface (ANNI) provides a learning process that operates through a series of proprietary algorithms derived from the inherent search-and-destroy behavior of human antibodies. ANNI, as described with respect to U.S. Patent Publication 2014/0215621 and entitled “System, method, and apparatus for providing network security,” and is incorporated herein by reference in its entirety. As the ANNI solution learns, it gets faster and stronger over time. ANNI has proven adaptable to a range of problem sets characterized by high data volume and the need to identify change and derive context from complex data.

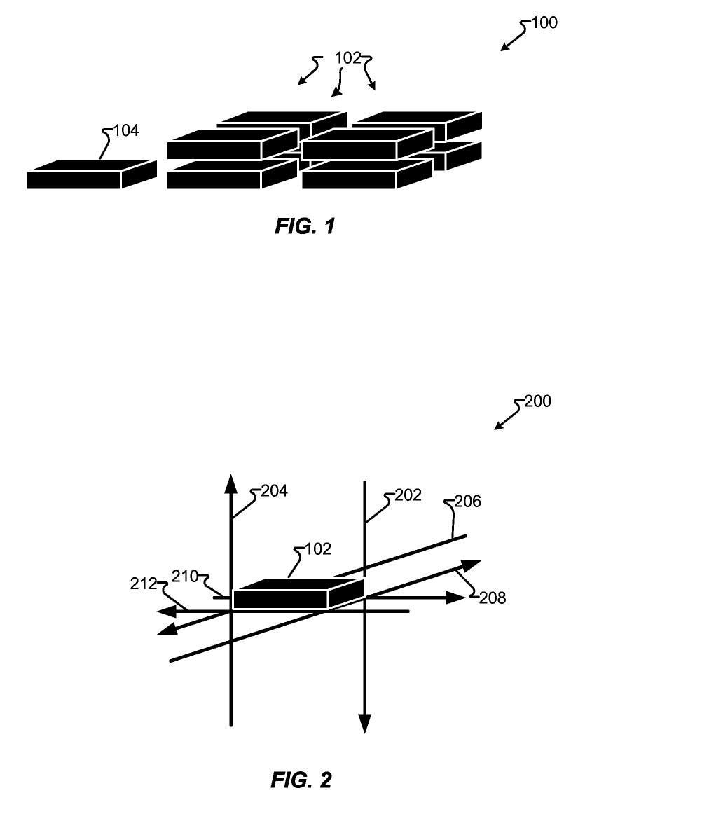

FIG. 1 shows an illustrative multi-core processor 100 in accordance with embodiments of the present disclosure. In one embodiment, a number of cores 102 are arranged in a three-dimensional array, such as the illustrated 2×2×2. As can be appreciated by those of ordinary skill in the art, other configurations are contemplated without departing from the teachings provided herein. For example, non-cube configurations (e.g., 2×3×4, 4×4×3, etc.) and cube configurations (e.g., 3×3×3, 4×4×4, etc.) may be provided. In another embodiment, shared memory 104 is accessible by each of the number of cores 102.

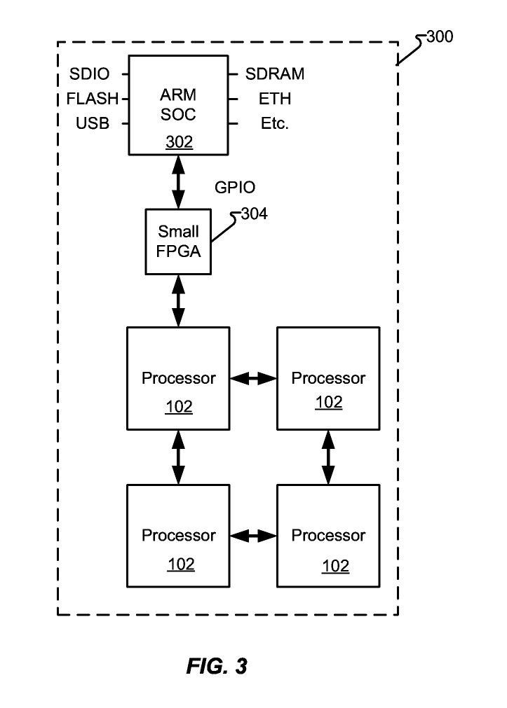

FIG. 2 shows an illustrative network-on-chip 200 in accordance with embodiments of the present disclosure. In one embodiment, lanes 202, 204, 206, 208, 210, 212, 214 provide core-to-core, core-to-memory, memory-to-core, core-to-off-chip, and/or core-from-off-chip. In another embodiment, directional line pairs (202 and 204, 206 and 208, and 210 and 212) are dedicated to a single type of communication, such as on-chip write traffic, off-chip write traffic, and all read traffic.

FIG. 3 shows an illustrative board 300 in accordance with embodiments of the present disclosure. Board 300 may be, entirely or in part, a high-temperature chip wrapping textile, such as the NASA compliant fire-resistant textile board capable of 1,700 hours of continuous operation at 500 degrees Celsius. In one embodiment, Advanced RISC Machines System-on-chip (ARM SOC) 302 is provided and may further comprise a number of communication interfaces. ARM SOC 302 is logically connected to small FPGA 304 via a general purpose input-output. Small FPGA 304 is then logically connected to a number of processors 102, such as a quad of processors 102.

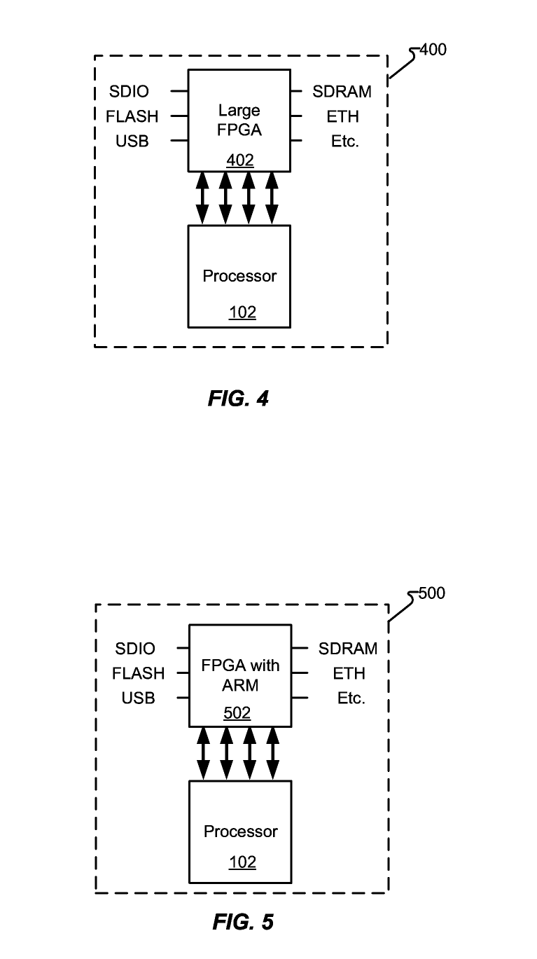

FIG. 4 shows an illustrative board 400 in accordance with embodiments of the present disclosure. Board 400 may be, entirely or in part, a high-temperature chip wrapping textile, such as the NASA compliant fire-resistant textile board capable of 1,700 hours of continuous operation at 500 degrees Celsius. In one embodiment, large FPGA 402 comprises a number of communication interfaces. In another embodiment, large FPGA 402 is logically attached, such as by for eLinks, to processor 102.

FIG. 5 shows an illustrative board 500 in accordance with embodiments of the present disclosure. Board 500 may be, entirely or in part, a high-temperature chip wrapping textile, such as the NASA compliant fire-resistant textile board capable of 1,700 hours of continuous operation at 500 degrees Celsius. In one embodiment, FPGA with ARM 502 comprises a number of communication interfaces. In another embodiment, FPGA with ARM 502 is logically attached, such as by for eLinks, to processor 102.

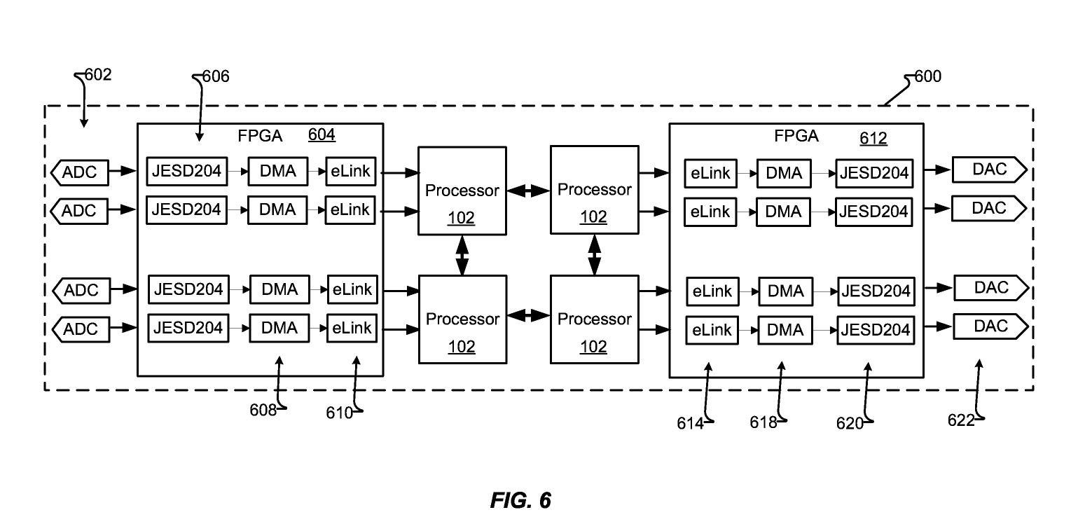

FIG. 6 shows an illustrative board 600 in accordance with embodiments of the present disclosure. Board 600 may be, entirely or in part, a high-temperature chip wrapping textile, such as the NASA compliant fire-resistant textile board capable of 1,700 hours of continuous operation at 500 degrees Celsius. In another embodiment, a number of analog-to-digital converters 602 are logically connected to FPGA 604. In turn, FPGA 604 is connected to a number of processors 102, such as a quad of processors 102, and then logically connected to FPGA 612. FPGA 612 is logically connected to a number of digital-to-analog converters 622.

In another embodiment, FPGA 604 comprises a number of serial interface chips 606, such as JESD204, receiving the signals from the number of ADC 602. Serial interface chips 606 are then logically connected to a number of direct memory access (DMA) 608, and eLink 610.

In another embodiment, FPGA 612 comprises a number of eLink 614 logically connected to a number of DMA 618, and in turn logically connected to serial interface chips 620.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor (GPU or CPU) or logic circuits programmed with the instructions to perform the methods (FPGA). These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Specific details were given in the description to provide a thorough understanding of the embodiments. However, it will be understood by one of ordinary skill in the art that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments were described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

While illustrative embodiments of the disclosure have been described in detail herein, it is to be understood that the inventive concepts may be otherwise variously embodied and employed, and that the appended claims are intended to be construed to include such variations, except as limited by the prior art.

What is claimed is:

1. A small form factor high performance computing platform, comprising:
a plurality of computational nodes, each computational node comprising a multi-core processor,
a memory comprising a shared portion and a plurality of local memory segments associated with each of the computational nodes;
a network-on-chip operable to provide data communication within the platform and comprising a low-latency mesh having first, second, and third interlocking structures and wherein on-chip write traffic of the data communication is allocated to the first interlocking structure, off-chip write traffic within the platform is allocated to the second interlocking structure, and on-chip and off-chip read within the platform traffic is allocated to the third interlocking structure; and
an off-chip input-output interface operable to facilitate communications with an external component.

2. The platform of claim 1, wherein the plurality of computational nodes are arranged in a three-dimensional array having at least two computational nodes on each of the three substantially orthogonal axes of the three-dimensional array.

3. The platform of claim 2, wherein the at least two computational nodes on each of the three substantially orthogonal axes of the three-dimensional array are four computational nodes on each of the three substantially orthogonal axes of the three-dimensional array.

4. The platform of claim 2, wherein the off-chip input-output interface comprises four links, wherein the platform comprises a first link on a first facet of the platform along the first orthogonal axis, a second link on a second facet of the platform along the first orthogonal axis and opposite the first facet, a third link on a third facet of the platform along the second orthogonal axis, and a fourth link on a fourth facet of the platform along the second orthogonal axis and opposite the third facet.

5. The platform of claim 4, wherein the wherein at least one of the first, second, third, and fourth links comprise a field programmable gate array.

6. The platform of claim 1, wherein each of the plurality of computational nodes comprises a reduced instruction set processor.

7. The platform of claim 1, wherein each of the plurality of computational nodes, memory, network-on-chip, and off-chip input-output interface is embodied within a single blade.

8. The platform of claim 1, wherein at least one of the plurality of computational nodes, memory, network-on-chip, and off-chip input-output interface is wrapped in high temperature textile chipset wrapping.

9. The platform of claim 1, wherein the off-chip input-output interface utilizes source synchronous low voltage differential signaling.

10. The platform of claim 1, wherein the memory comprises a number of banks and wherein the memory is operable to allow simultaneous memory access by an instruction fetch engine, computational node local load-store instructions, and computational node non-local load-store instructions by load-store transactions.

11. A computational blade, comprising:
a number of computer chips, each chip comprising:
a plurality of computational nodes, each computational node comprising a multi-core processor,
a memory comprising a shared portion and a plurality of local memory segments associated with each of the computational nodes;
a network-on-chip operable to provide data communication within the platform and comprising a low-latency mesh having first, second, and third interlocking structures and wherein on-chip write traffic of the data communication is allocated to the first interlocking structure, off-chip write traffic within the platform is allocated to the second interlocking structure, and on-chip and off-chip read within the platform traffic is allocated to the third interlocking structure; and
an off-chip input-output interface operable to facilitate communications with an external component.

12. The computational blade of claim 11, wherein the plurality of computational nodes are arranged in a three-dimensional array having at least two computational nodes on each of the three substantially orthogonal axes of the three-dimensional array.

13. The computational blade of claim 12, wherein the at least two computational nodes on each of the three substantially orthogonal axes of the three-dimensional array are four computational nodes on each of the three substantially orthogonal axes of the three-dimensional array.

14. The computational blade of claim 12, wherein the off-chip input-output interface comprises four links, wherein the platform comprises a first link on a first facet of the platform along the first orthogonal axis, a second link on a second facet of the platform along the first orthogonal axis and opposite the first facet, a third link on a third facet of the platform along the second orthogonal axis, and a fourth link on a fourth facet of the platform along the second orthogonal axis and opposite the third facet.

15. The computational blade of claim 14, wherein the wherein at least one of the first, second, third, and fourth links comprise a field programmable gate array.

16. The computational blade of claim 10, wherein each of the plurality of computational nodes comprises a reduced instruction set processor.

17. The computational blade of claim 10, wherein each of the plurality of computational nodes, memory, network-on-chip, and off-chip input-output interface is embodied within a single blade.

18. The computational blade of claim 10, wherein at least one of the plurality of computational nodes, memory, network-on-chip, and off-chip input-output interface is wrapped in high temperature textile chipset wrapping.

19. A server, comprising:
a number of computational blades;
a backplane operable to provide communication between at least two of the number of blades; and
wherein each blade comprises;
at least one computer chip, further comprising, a plurality of computational nodes, each computational node comprising a multi-core processor,
a memory comprising a shared portion and a plurality of local memory segments associated with each of the computational nodes;
a network-on-chip operable to provide data communication within the platform and comprising a low-latency mesh having first, second, and third interlocking structures and wherein on-chip write traffic of the data communication is allocated to the first interlocking structure, off-chip write traffic within the platform is allocated to the second interlocking structure, and on-chip and off-chip read within the platform traffic is allocated to the third interlocking structure; and
an off-chip input-output interface operable to facilitate communications with an external component.

20. The server of claim 19, wherein:
the plurality of computational nodes are arranged in a three-dimensional array having at least two computational nodes on each of the three substantially orthogonal axes of the three-dimensional array; and
the off-chip input-output interface comprises four links, wherein the platform comprises a first link on a first facet of the platform along the first orthogonal axis, a second link on a second facet of the platform along the first orthogonal axis and opposite the first facet, a third link on a third facet of the platform along the second orthogonal axis, and a fourth link on a fourth facet of the platform along the second orthogonal axis and opposite the third facet.
